(19) United States
(12) Patent Application Publication
(10) Pub. No.: US 2004/0177379 A1
(43) Pub. Date: Sep. 9, 2004

(54) Method and apparatus for isolating signals in RF circuits and systems

(75) Inventor: Hermann Gysel, Cambria, CA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/382,545

(22) Filed: Mar. 6, 2003

(51) Int. Cl. H04N 7/173; H04N 7/16

(52) U.S. Cl. 725/128; 725/116; 725/117; 725/146; 725/147

(57) ABSTRACT

An apparatus for providing electrical isolation between two ports prevents a potentially interfering signal input from one port from reaching the other port. A first circuit path passes a first signal in a first direction from a first port of the two ports to a second port of the two ports. A second path inverts the potentially interfering signal attempting to pass in a second direction opposite the first direction from the second port to the first port and adds the inverted signal to the potentially interfering signal at the first port to thereby cancel any affect the potentially interfering signal might have at the first port. According to one exemplary embodiment of the apparatus, the first circuit path includes two directional couplers—a first directional coupler coupled to the first port and a second directional coupler coupled to the second port. A delay line is coupled between the first and second directional couplers to match a time needed for a signal to pass through the second path. An inverting amplifier is coupled between the first and second directional couplers to perform the necessary inversion. The inverting amplifier includes a gain having a magnitude matching a magnitude of a total gain of the first and second directional couplers but opposite in sign to the total gain of the first and second directional couplers. Impedance matching resistors are coupled to the two directional couplers.

### FIELD OF THE INVENTION

The present invention relates generally to methods and apparatuses for providing isolation between signals and more particularly to a method and apparatus for providing isolation between two signals in a broadband RF system, such as a cable television system.

### BACKGROUND

In RF circuits and systems, it is often necessary to combine two or more signals. Hybrid combiners reach port-to-port isolation around 30 dB. In some situations, this is not enough—50 dB or more would be desirable. Classical microwave isolators are narrowband devices and cannot be used in wideband applications, such as in CABLE Television (CATV) equipment.

The present invention is therefore directed to the problem of developing a method and apparatus for electrically isolating two ports from each other that can operate over a broad frequency band and do so in an economical fashion while providing significant isolation.

### SUMMARY OF THE INVENTION

The present invention solves these and other problems by providing a method and apparatus for isolating two signals that can operate over a broad frequency band.

According to an exemplary embodiment, a method for electrically isolating two signals provides two signal paths between two ports, a first signal path in which an incoming signal is delayed but otherwise unaffected and a second signal path, opposite the first signal path, in which a potentially interfering signal is inverted, and added to the incoming signal that has been delayed to remove and otherwise cancel the effect of the potentially interfering signal.

### BRIEF DESCRIPTION OF THE DRAWINGS

FIG. 1 depicts an exemplary embodiment of an apparatus for canceling an effect of a potentially interfering signal in a broadband circuit.

FIG. 2 depicts an exemplary embodiment of a method for canceling the effect of a potentially interfering signal in a broadband circuit.

FIG. 3 depicts another exemplary embodiment of a method for canceling the effect of a potentially interfering signal in a broadband circuit.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

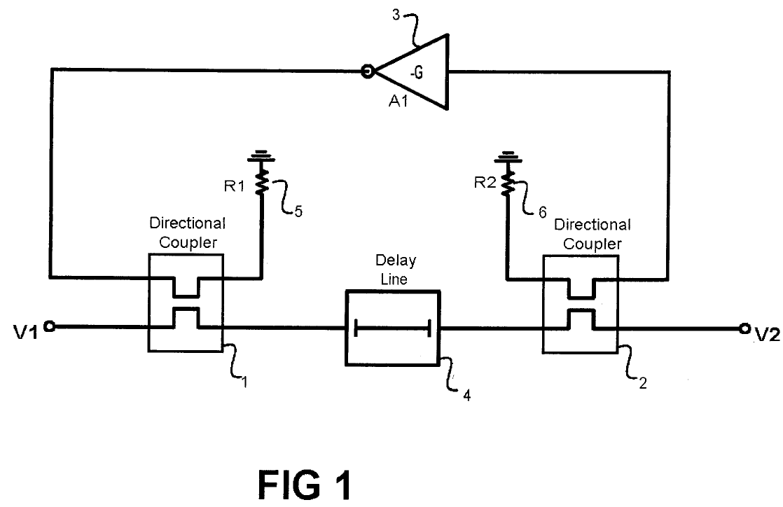

Referring to FIG. 1, shown therein is an exemplary embodiment of an apparatus for providing additional isolation between two ports (1 and 2). The embodiment includes a first directional coupler 1, a delay line 4, a second directional coupler 2, two resistors 5, 6, and a feedback inverting amplifier 3 with a gain of −G.

The two directional couplers are standard directional couplers used in RF systems. An example of such a directional coupler is EMDC-16-2-75 available from MA-COM.

The delay line comprises an inductive network or a coaxial cable having a transmission delay selected as discussed below. Such delay lines are well known in the art. There are other ways to affect the same delay, any of which could be employed in this embodiment as is known to those of skill in this art.

Amplifier 3 is a standard MMIC amplifier having a negative gain in the feedback direction, thereby effecting the desired cancellation of a signal input to port 2. An example if a suitable amplifier includes a Siemens NGA-586.

Resistors 5, 6 are standard resistors.

The above exemplary embodiment operates as follows. Signal VI enters port 1. Directional Coupler 1 passes V1 essentially unaffected. Delay line 4 provides some delay to Signal V1, as will be discussed below. Directional Coupler 2 passes the delayed version of Signal V1 essentially unaffected (e.g., it has the same transfer function as directional coupler 1). Signal V1 is then output at port 2.

A signal V2, which is a potentially interfering signal that would likely interfere with signal V1, entering port 2 is inversely amplified in amplifier 3, sampled in the directional coupler 1, delayed and coupled back into the main line (input V1) with directional coupler 2. The amplifier 3 operates to invert the Signal V2 for cancellation. The gain of the amplifier is matched to the gains of the two directional couplers so that:

G=CL₁+CL₂

The impedances of resistors R1 5 and R2 6 are selected to match the impedance of the input. Examples include 50 ohm or 75 ohm impedances.

The delay of the delay line 4 is selected to match the processing delays of the feedback path. One technique for determining the delay is to input a known signal into port 2 and measure its delay relative to the original. While this delay may have some frequency dependencies, a value can usually be selected that approximates the delay of the feedback path across the frequency band of interest.

This exemplary embodiment produces 20-30 dB of cancellation from 50-350 MHz. Smaller components can this affect up in frequency to a desired value in the band of interest, e.g., up to in excess of one Gigahertz.

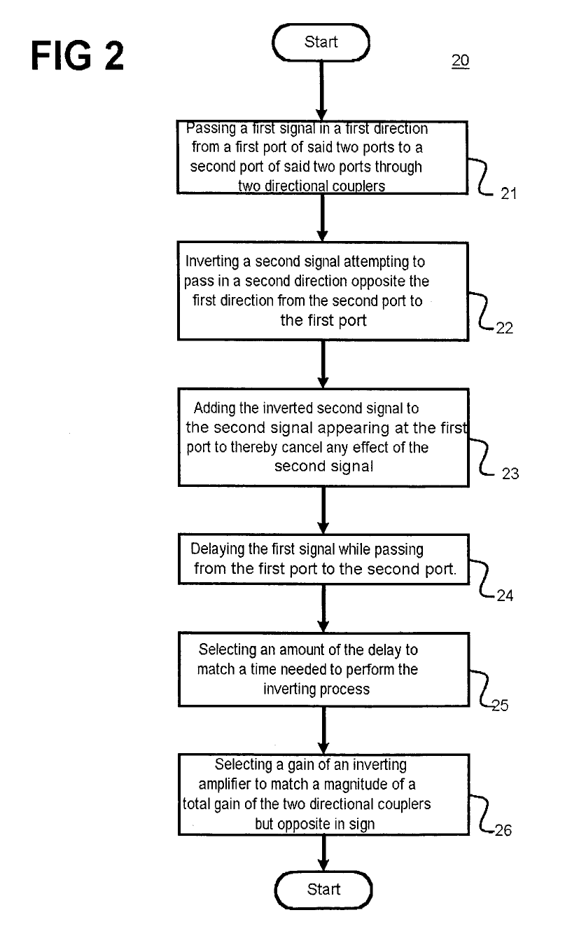

According to another aspect of the present invention, an exemplary embodiment 20 of a method for electrically isolating two ports is shown in FIG. 2. The method passes a first signal in a first direction from a first port of said two ports to a second port of said two ports through two directional couplers (element 21). The method then inverts a second signal attempting to pass in a second direction opposite the first direction from the second port to the first port (element 22) and adds the inverted second signal to the second signal appearing at the first port to thereby cancel any effect of the second signal (element 23).

According to an exemplary embodiment of the above method, the first signal is coupled from the first port to the second port via a first directional coupler coupled to the first port and a second directional coupler coupled to the second port. To accommodate processing delays, the first signal is delayed in its passing from the first port to the second port (element 24). An amount of the delay is selected to match a time needed to perform the inverting process (element 25). This can be on the order of a few to several picoseconds.

According to another exemplary embodiment of the above method, the inverting includes coupling the second signal through an inverting amplifier coupled between the first and second directional couplers. A gain of the inverting amplifier is selected to match a magnitude of a total gain of the first and second directional couplers but opposite in sign to the total gain of the first and second directional couplers (element 26).

According to still another exemplary embodiment of the above method, impedance matching is performed to match the input impedance using a first impedance matching resistor coupled to the first directional coupler. The output impedance is matched using a second impedance matching resistor coupled to the second directional coupler.

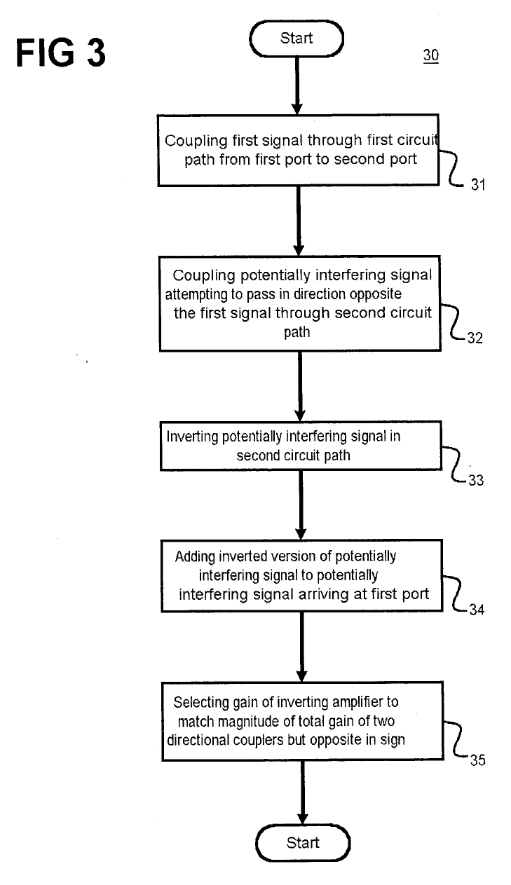

According to another aspect of the present invention, an exemplary embodiment 30 of a method for providing electrical isolation between two ports is shown in FIG. 3. This embodiment 30 includes coupling a first signal through a first circuit path from a first port of the two ports to a second port of said two ports (element 31). Simultaneously, this method provides for coupling a potentially interfering signal attempting to pass in a direction opposite the first signal from the second port to the first port through a second circuit path (element 32). The second circuit path inverts the potentially interfering signal (element 33) and adds the inverted version of the potentially interfering signal to the potentially interfering signal arriving at the first port (element 34), thereby canceling any effect the potentially interfering signal may have upon arriving at the first port. As with the above embodiment, the gain of the inverting amplifier used is selected to match the gain of two directional couplers used in the coupling steps (element 35).

Although various embodiments are specifically illustrated and described herein, it will be appreciated that modifications and variations of the invention are covered by the above teachings and are within the purview of the appended claims without departing from the spirit and intended scope of the invention. For example, certain implementations of the delay line and other elements of the exemplary embodiments are disclosed, however, other implementations may suffice without departing from the scope of the present invention. Furthermore, these examples should not be interpreted to limit the modifications and variations of the invention covered by the claims but are merely illustrative of possible variations.

What is claimed is:

1. An apparatus for providing electrical isolation between two ports comprising:
a first circuit path passing a first signal in a first direction from a first port of said two ports to a second port of said two ports; and
a second path inverting a potentially interfering signal attempting to pass in a second direction opposite the first direction from the second port to the first port and adding to said potentially interfering signal at the first port to thereby cancel said potentially interfering signal.

2. The apparatus according to claim 1, wherein the first circuit path comprises a first directional coupler coupled to the first port and a second directional coupler coupled to the second port.

3. The apparatus according to claim 2, further comprising a delay line coupled between the first and second directional couplers.

4. The apparatus according to claim 3, wherein the delay line includes a delay selected to match a time needed for a signal to pass through the second path.

5. The apparatus according to claim 1, wherein the second circuit path comprises an inverting amplifier coupled between the first and second directional couplers.

6. The apparatus according to claim 5, wherein the inverting amplifier includes a gain having a magnitude matching a magnitude of a total gain of the first and second directional couplers but opposite in sign to the total gain of the first and second directional couplers.

7. The apparatus according to claim 1, further comprising a first impedance matching resistor coupled to the first directional coupler.

8. The apparatus according to claim 7, further comprising a second impedance matching resistor coupled to the second directional coupler.

9. A method for electrically isolating two ports comprising:
passing a first signal in a first direction from a first port of said two ports to a second port of said two ports;
inverting a second signal attempting to pass in a second direction opposite the first direction from the second port to the first port; and
adding the inverted second signal to said second signal at the first port to thereby cancel any effect of said second signal.

10. The method according to claim 9, further comprising coupling the first signal from the first port to the second port via a first directional coupler coupled to the first port and a second directional coupler coupled to the second port.

11. The method according to claim 10, further comprising delaying the first signal while passing the first signal from the first port to the second port.

12. The method according to claim 11, further comprising selecting an amount of the delay to match a time to perform the inverting.

13. The method according to claim 10, wherein the inverting includes coupling the second signal through an inverting amplifier coupled between the first and second directional couplers.

14. The method according to claim 13, further comprising selecting a gain of the inverting amplifier to match a magnitude of a total gain of the first and second directional couplers but opposite in sign to the total gain of the first and second directional couplers.

15. The method according to claim 10, further comprising matching an input impedance using a first impedance matching resistor coupled to the first directional coupler.

16. The method according to claim 15, further comprising matching an output impedance using a second impedance matching resistor coupled to the second directional coupler.

17. A method for providing electrical isolation between two ports comprising:
coupling a first signal through a first circuit path from a first port of said two ports to a second port of said two ports; and
coupling a potentially interfering signal attempting to pass in a direction opposite the first signal from the second port to the first port through a second circuit path that inverts the potentially interfering signal and adds an inverted version of the potentially interfering signal to the potentially interfering signal arriving at the first port thereby canceling any effect of the potentially interfering signal at the first port.

18. The method according to claim 17, wherein the step of coupling the first signal includes coupling the first signal from the first port to the second port via a first directional coupler coupled to the first port and a second directional coupler coupled to the second port.

19. The method according to claim 17, further comprising delaying the first signal while passing the first signal from the first port to the second port.

20. The method according to claim 19, further comprising selecting an amount of the delay to match a time to couple the potentially interfering signal through the second circuit path.

21. The method according to claim 18, wherein said coupling the potentially interfering signal includes coupling the potentially interfering signal through an inverting amplifier coupled between the first and second directional couplers.

22. The method according to claim 21, further comprising selecting a gain of the inverting amplifier to match a magnitude of a total gain of the first and second directional couplers but opposite in sign to the total gain of the first and second directional couplers.

23. The method according to claim 18, further comprising matching an input impedance using a first impedance matching resistor coupled to the first directional coupler.

24. The method according to claim 23, further comprising matching an output impedance using a second impedance matching resistor coupled to the second directional coupler.
